(19) United States
(12) Patent Application Publication
(10) Pub. No.: US 2004/0107642 A1
(43) Pub. Date: Jun. 10, 2004

(54) Sliding door system

(75) Inventor: Arne Liebscher, Herdecke (DE)

Correspondence Address: COHEN, PONTANI, LIEBERMAN & PAVANE, Suite 1210, 551 Fifth Avenue, New York, NY, 10176, US

(73) Assignee: DORMA GmbH + Co. KG

(21) Appl. No.: 10/413,025

(22) Filed: Apr. 14, 2003

(30) Foreign Application Priority Data
Apr. 16, 2002 (DE) 102 16 983.7-25

(51) Int. Cl. E05B 65/10

(52) U.S. Cl. 49/141

(57) ABSTRACT

The invention pertains to a sliding door system with at least one automatically driven sliding leaf, which is guided on a traveling carriage and a support profile, where the drive and a runway rail are mounted in a housing above the sliding leaf, and where the sliding leaf can be swung open if necessary in the outward direction around a vertical axis. To create a sliding door system which ensures a reliable and effective sealing function, especially with respect to smoke and fire, which is suitable for use in escape and rescue routes, and which can be used anywhere, regardless of the structural conditions, the sliding leaf, when in the closed position, has sealing-devices, which are active at all times, on all horizontal and vertical edges.

### SPECIFICATION

The invention pertains to a sliding door system according to the introductory clause of claim 1.

These types of sliding door systems and their sliding leafs are opened and closed by an electric drive and a corresponding control unit. These types of sliding door systems are often used to produce a leak-proof seal for interior spaces and therefore must be provided with effective sealing measures in the area of their contact edges and at other points where leakage is likely to occur. In the case of fire, the escape of smoke must be effectively and reliably prevented. When such systems are used in escape and rescue routes, furthermore, the sliding leafs and possibly their side parts can be pivoted around a vertical axis of rotation and thus opened in the escape direction when a panic situation occurs.

A sliding door system of this type is known from DE 197 53 132 A1, where expanding fire protection material is used to seal off several intermediate spaces located between the sliding leafs and the surrounding periphery. The disadvantage here is that the fire protection material is not activated until the temperature has been raised sufficiently by the fire. The only way to prevent the leakage of smoke before that point is reached, however, is by the use of additional measures, involving the use of sealing devices which are activated when a sensor-measured threshold value is exceeded.

It is also known that, when in their closed position, the sliding leafs of door systems can be sealed against the floor by lowerable sealing strips. A sealing device of this type is described in, for example, DE 35 26 720 C2. The disadvantage here is that the release device projects from the main contact edge of the sliding leaf but is not protected in any way.

It is therefore the task of the present invention to create a sliding door system which guarantees a reliable and effective sealing function especially against smoke and fire, and which is also suitable for use in escape and rescue routes. A sliding door system of this type should also be usable anywhere, regardless of the type of structure in question.

This task is accomplished by the features stated in claim 1. Advantageous embodiments of the object of claim 1 can be derived from the subclaims.

The sliding door system according to claim 1 is a door system which is always sealed when in the closed state, because the sliding leafs always provide a complete seal regardless of the boundary conditions such as smoke or fire. When smoke or fire occurs, there is no need to activate any additional sealing devices of any kind, which means that there is no need for any sensor-activated devices to create a smoke-tight seal. As a result of the continuous sealing function, the sliding door system is also suitable for use in situations where good sound damping or thermal insulation is also required and also in situations where nearly dust-free areas are to be created. As an option, the sliding door system according to the invention can also have stationary side parts which can be designed to swing open in case of need. The overall design of the system is such that the sliding doors can be used in any type of structure and adapted to the prevailing construction tolerances.

The actuation or automatic drive of the sliding leafs can be adapted to various closing forces, which vary as a function of the number and type of sealing measures required in the specific case. A smoke alarm system can also be provided, so that the sliding leafs can be closed by a motor when an alarm is given and then locked so that they can no longer be opened in the sliding direction. The locking function can make use of the standard locking mechanism of the sliding door system, which holds the traveling carriages of the sliding leafs in place.

A sealing strip is integrated invisibly into the transverse profile at the bottom of the sliding leaf; this strip is lowered automatically onto the floor to form a seal when the door system is closed. A release device for the spring-loaded sealing strip is actuated by a rotatably supported cam located in the longitudinal profile at the secondary contact edge of the sliding leaf; this cam is turned by a stationary ramp when the sliding leaf moves in the closing direction. That the components which control and release the sealing strip are located within the frame at the secondary contact edge means that they are shifted into a protected area. No parts of any kind project into the room, where they could possibly be damaged or manipulated by passers-by. Because of the way in which the ramp and the cam interact according to the invention to release the sealing strip, the actuating force increases continuously, which is advantageous especially with respect to control, because no sluggish blockade situation is created.

Because the release device and the cam are mounted permanently in the frame of the sliding leaf and are thus aligned precisely with each other, they never need to be readjusted. The cam, the axle body of the cam, and a floor glide on the bottom form a compact assembly. The cam has a projecting lobe, which slides along the ramp. On the radially opposite side of the cam there is a slide block, which actuates the release device. Axially projecting stops at the bottom of the slide block prevent the cam from turning too far. It is advantageous to fabricate the cam out of aluminum, because this reduces wear, especially on the contact surfaces. The cam and the floor glide are accessible through openings in the longitudinal profile of the sliding leaf, so that they can be replaced or so that the height of the components can be adjusted.

When the door is opened, no additional force component is required to retract the sealing strip, because the sealing strip's own elastic restoring force fulfills this function. The release device also presses the cam back into the starting position. The cam is supported rotatably on the axle body; when the sliding leaf is swung open to open an escape route, the release device therefore travels by a rotational movement around the slide block of the cam, which remains in its position, with the result that the release device is automatically pulled back and the sealing strip rises from the floor. The friction and wear which occur during the pivoting of the sliding leaf are therefore reduced. It is advantageous for the sliding leaf to be swung into its closed position by a door closer, which is installed under cover at the top, inside the frame. Here again, the slide block of the cam actuates the release device to lower the sealing strip back onto the floor. It follows from this that there is no interference with the function between the cam and the release device either during or after the swinging open or swinging closed of the sliding leaf.

The runway rail which guides the sliding leaf along the floor and the ramp which controls the cam are screwed permanently to the attachment of the side part to the floor, which guarantees their precise alignment with the cam and the reliable operation of the release function. As a result, the sliding leaf is also guided precisely across a vertical seal located on the side part. In an advantageous embodiment, the runway rail and a threshold, onto which the sealing strip is lowered, can be designed as a one-piece profile.

The functional area pertaining to the release of the bottom sealing strip is completely outside the vertical sealing plane. The vertical sealing at the secondary contact edge between the stationary side part and the sliding leaf is advantageously provided by an elastic sealing profile. The sealing profile has the shape of a lip to minimize the force required to actuate the seal and thus to minimize the load on the drive. That the motion occurs along a wedge-shaped vertical profile has the effect of reducing the load.

Sealing profiles with sealing lips are mounted on the main contact edge; even in the case of a door system with two leafs, these profiles and lips ensure a good seal after the sliding leafs have been swung shut. Here, too, the actuating force to be provided by the drive is minimized.

The door system is also sealed adequately along the top horizontal edges. An automatically actuated sealing strip between the drive housing and the support profile of the sliding leaf provides the seal. This sealing strip is designed basically in the same way as the bottom sealing strip and is integrated into the housing. Slots are provided so that its position with respect to the support profile can be adjusted. The sealing strip is operated by way of a force-reducing lever mechanism, which is actuated by an arm mounted on the support profile. The arm has a plastic end piece, which can be adjusted in several directions and which is designed so that it can be mounted on or under the arm, depending on the preset height of the sliding leaf.

The housing is sealed off horizontally with respect to the ceiling by an extendable ceiling cover profile and possibly also by silicone. Lining panels, which can be extended toward the wall, are also mounted on the edge areas of the vertical columns. These panels can also be sealed with silicone if desired. The leakage points at the corners and transition areas are sealed by brush seals or by molded plastic parts.

Additional details, features, and advantages of the invention can be derived from the following description of preferred exemplary embodiments, illustrated in the drawings:

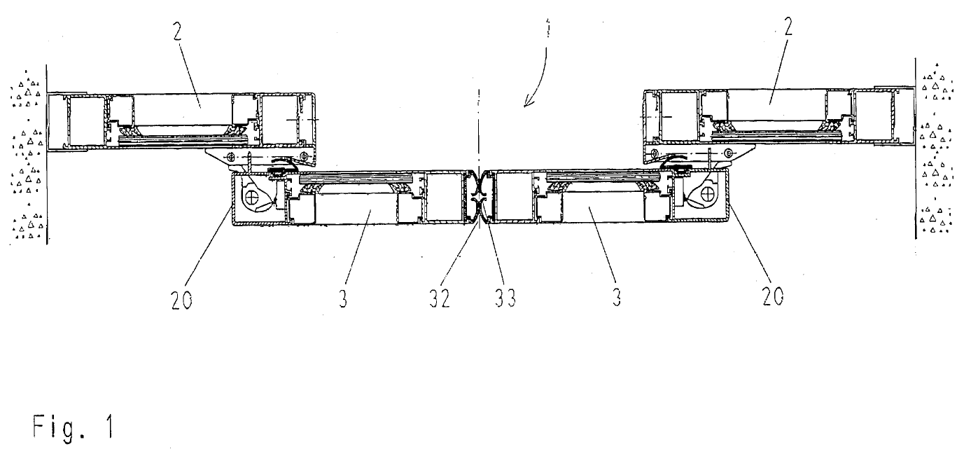

FIG. 1 shows a cross section, from above, of a sliding door system with side parts and sliding leafs in the closed state;

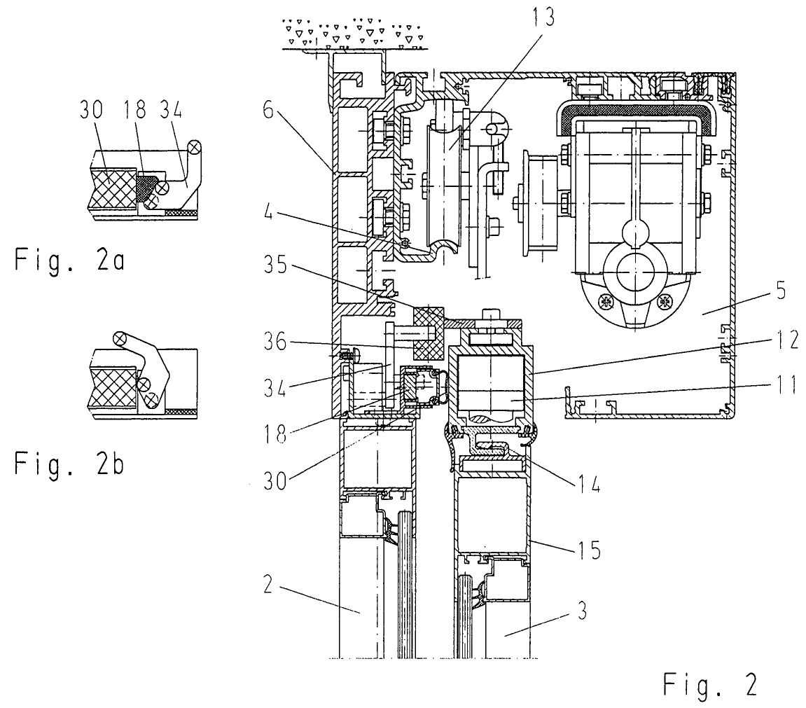

FIG. 2 shows a partial longitudinal section of a sliding door system according to FIG. 1;

FIG. 2a shows an enlarged plan view of part of FIG. 2, in which a sealing strip and a lever are in a first position;

FIG. 2b shows an enlarged plan view of part of FIG. 2, in which a sealing strip and a lever are in a second position;

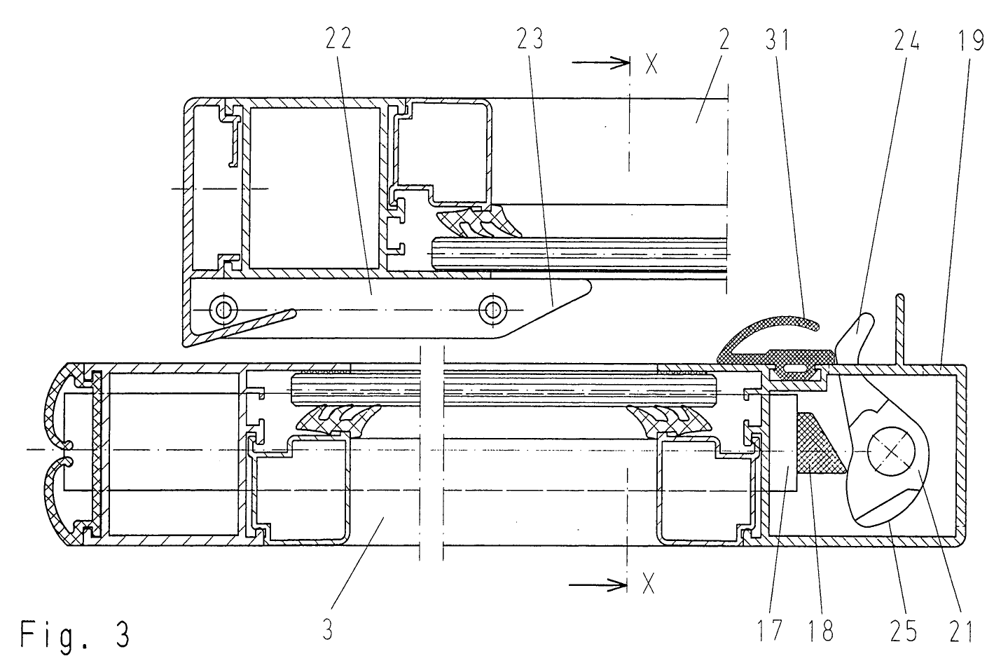

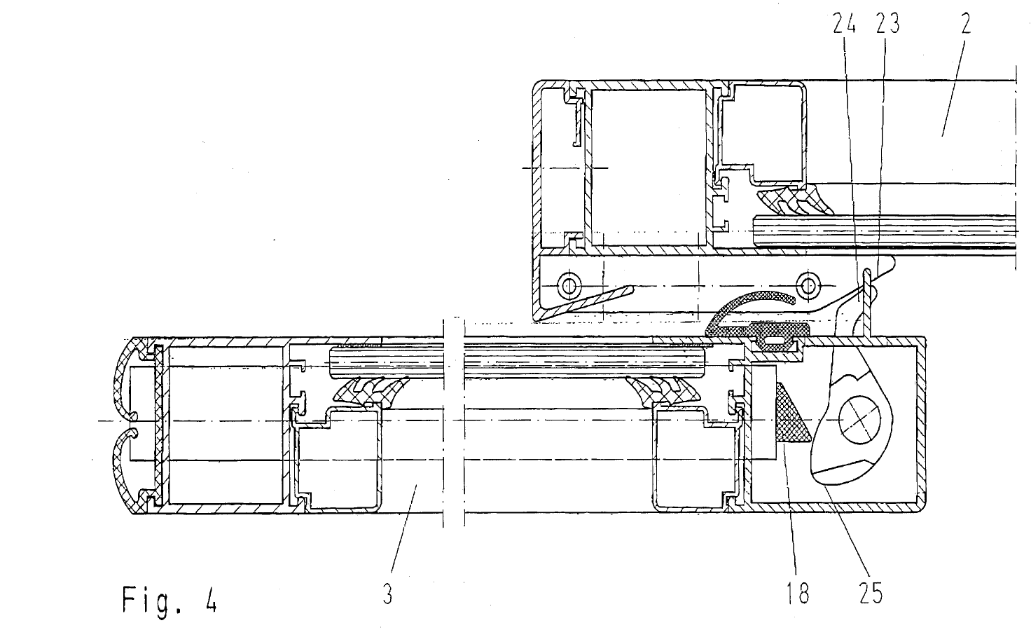

FIGS. 3-5 show enlarged views of part of the sliding door system according to FIG. 1 in various stages of the closing operation;

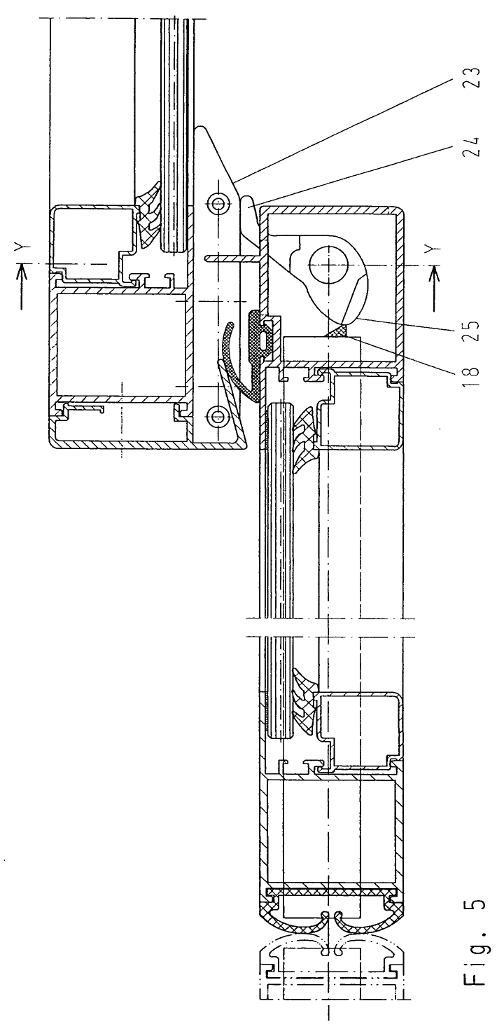

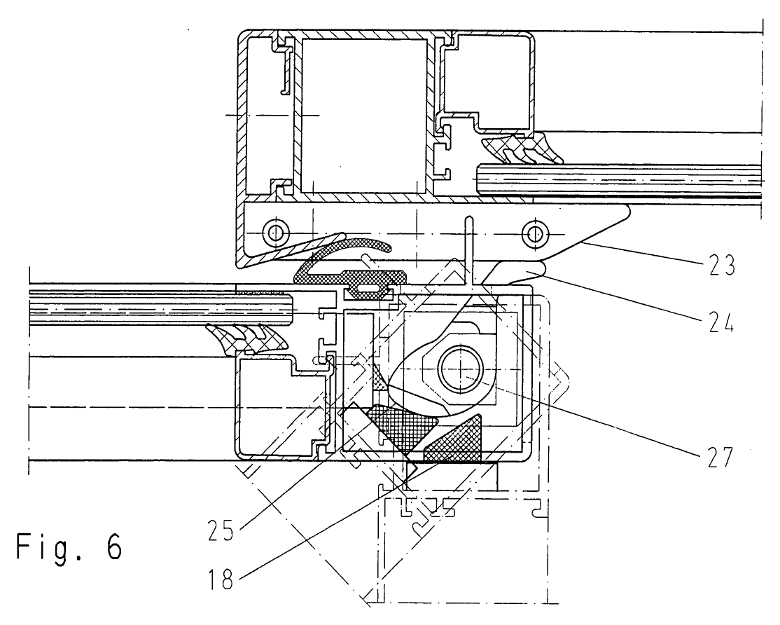

FIG. 6 shows the sliding door system according to FIG. 5 with the sliding leaf in various stages of the outward swinging movement, starting from the closed position;

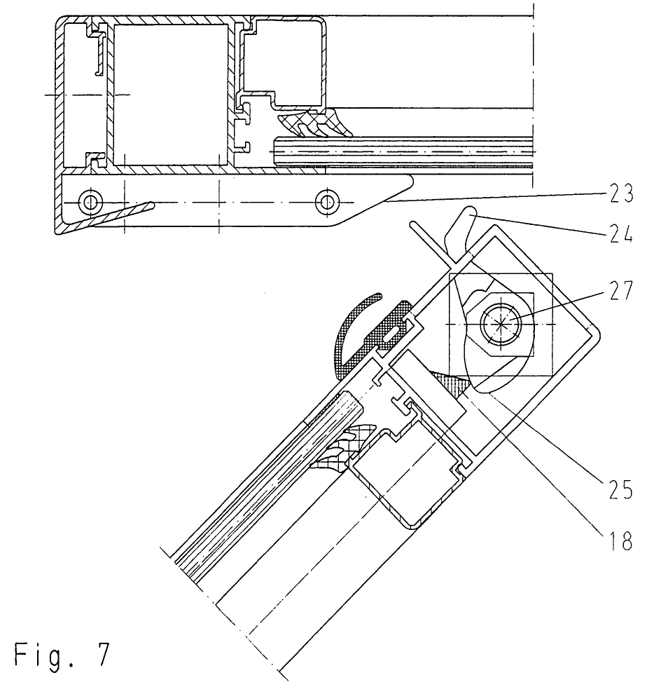

FIG. 7 shows the sliding door system according to FIG. 5, where the sliding leaf has been swung outward from the closed position;

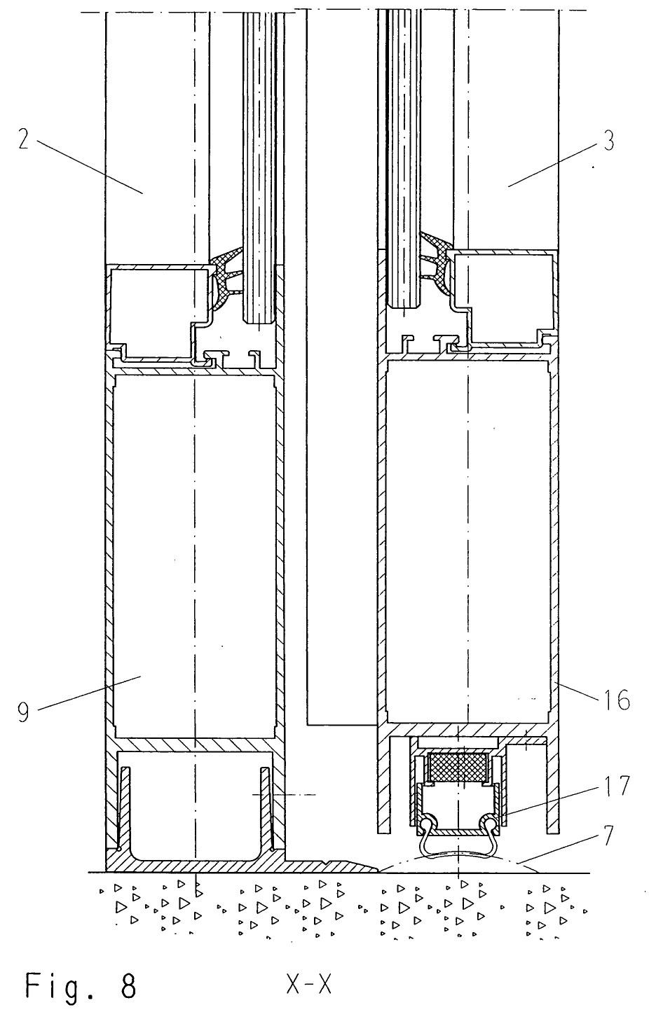

FIG. 8 shows part of a longitudinal cross section through the sliding door system along axis X-X of FIG. 3;

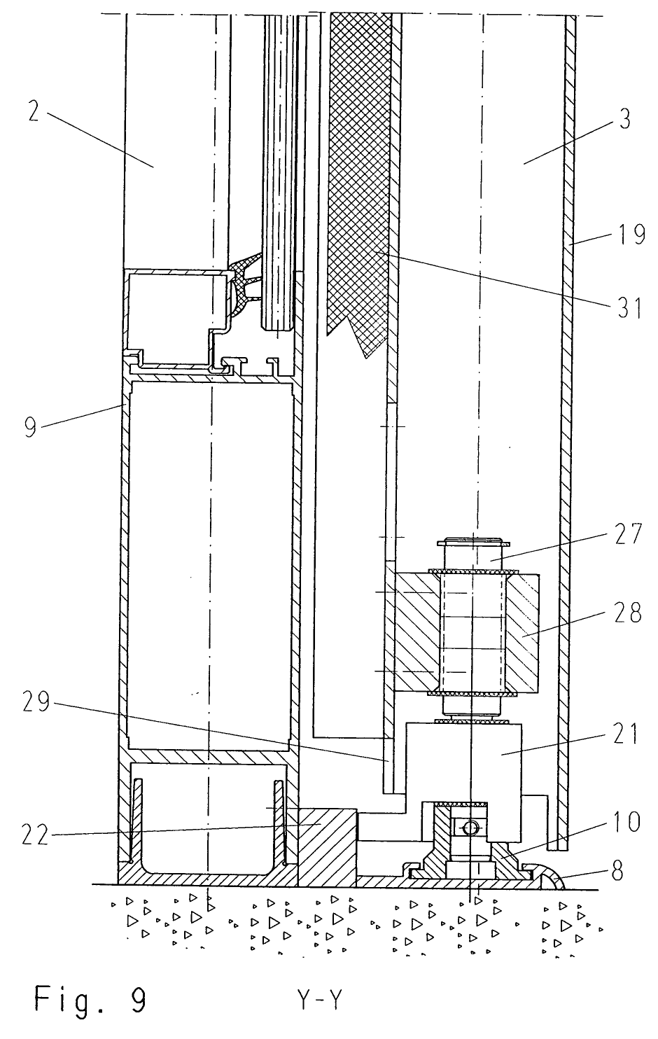

FIG. 9 shows part of a longitudinal cross section through the sliding door system along axis Y-Y of FIG. 5;

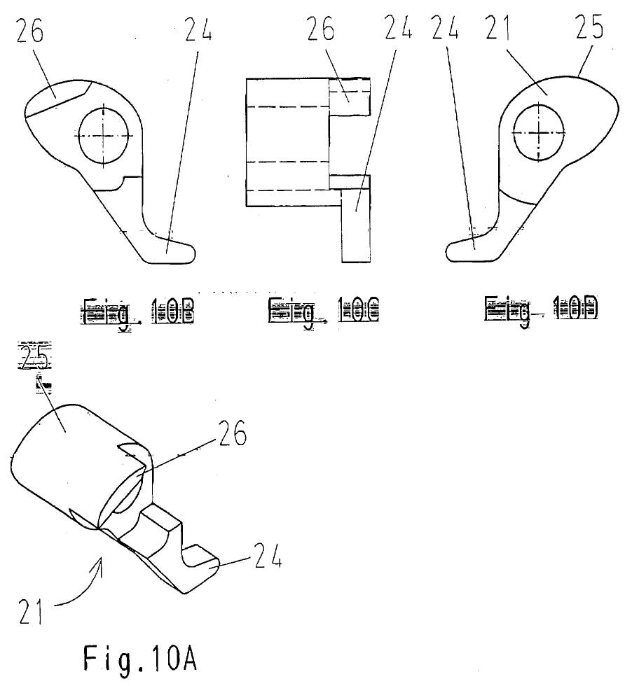

FIGS. 10a-d show various views of a cam; and

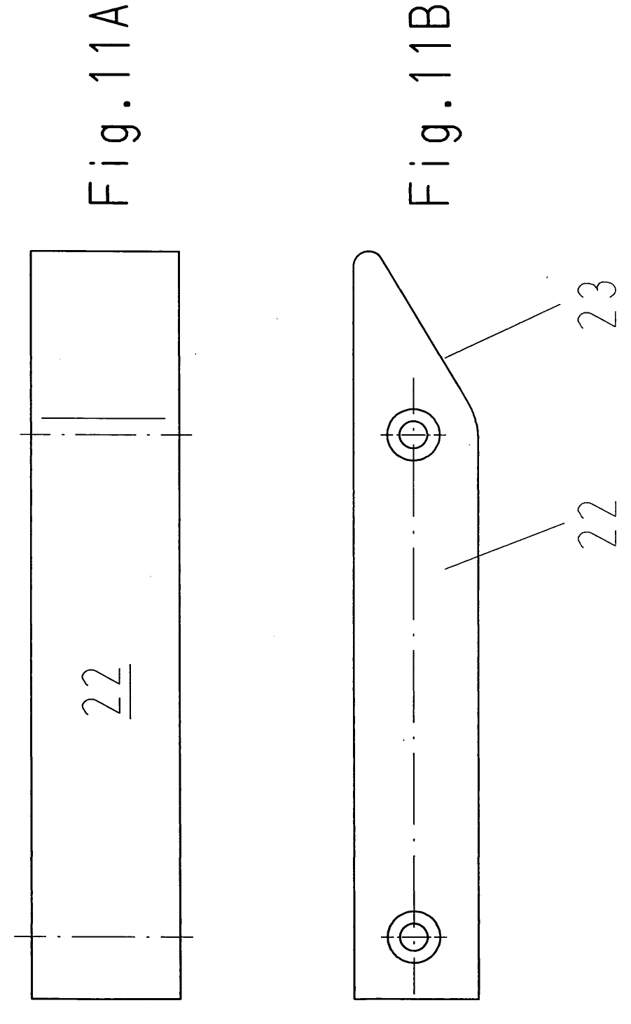

FIGS. 11a-b show various views of a ramp.

Although the invention is explained and described in the following in the form of a sliding door system with a smoke protection function, it can also be put into service wherever a tightly-sealing door system is used.

The illustrated sliding door system 1 consists of two stationary side parts 2 and two sliding leafs 3, which are guided so that they can slide back and forth between the side parts. Steel columns (not shown) are installed at the sides of an opening in a building. These columns extend between the floor and the ceiling, and a runway rail 4 and a housing 6, which supports a drive 5, are attached to them. The side parts 2 are attached laterally to the steel columns and also, at the top, to the housing 6. A threshold 7 and rails 8, which serve to guide the sliding leafs 3 along the floor, are permanently connected, and are preferably also connected to the frame 9 of the side parts 2. Floor glides 10 on the sliding leafs 3 are attached in a form-locking manner to the rails 8 and are free to slide along them.

Each sliding leaf 3 is attached pivotably to its own support profile 12 by an adjustable support arm 11; the support profile is connected in turn to the carriage 13, which travels along the runway rail 4. The sliding leaf 3 is kept in the normal position with respect to the support section 12 by interlocking profiles 14. When a panic situation occurs, these profiles are disconnected from each other, and the sliding leafs 3 are swung out of their normal position in the escape direction. Door closers (not shown) are installed under cover in the upper horizontal transverse profile 15 of the sliding leafs. These door closers have slide rail arms, which are connected to slide pieces in the support profile 12 above, which is open at the bottom. The closers make it possible for the leafs to swing back automatically into the normal position.

A spring-loaded sealing strip 17 is integrated invisibly into the transverse profile 16 at the bottom of each sliding leaf 3; when the door system 1 is closed, this strip is lowered automatically to the floor to form a seal. A release device 18 for the sealing strip 17 is actuated by a rotatably supported cam 21, which is located in a longitudinal profile 19 at the secondary sealing edge 20 of the sliding leaf 3; when the sliding leaf 3 travels in the closing direction, this cam is turned by a ramp 22, which is attached permanently to the side part 2. The ramp 22 is preferably fabricated as an injection-molded part and has an entrance bevel 23.

The cam 21 has a projecting lobe 24. Opposite it, on the cam 21, a radially ascending slide block 25 extends over a certain area. A stop 26, which projects axially from the bottom of the slide block 25, prevents the cam 21 from rotating too far.

The release device 18 and the cam 21 are positioned precisely with respect to each other, because the two components are premounted at the factory in permanent positions in the transverse profile 16 and in the longitudinal profile 19, respectively, of the sliding leaf 3. The cam 21, the axle body 27 of the cam, and the floor glide 10 attached to the bottom of the axle body form a compact assembly, the axle body 27 being supported with freedom to slide in a bearing block 28 mounted inside the longitudinal profile 19. The assembly is accessible through openings 29 in the longitudinal profile 19 of the sliding leaf 3, so that the components can be replaced or so that their height can be adjusted.

During a normal closing operation, the sliding leaf 3 is moved automatically by the drive 5. This operation starts from the completely open position, in which the sealing strip 17 is completely retracted into the transverse profile 16 at the bottom of the leaf. During the closing operation, the lobe 24 of the cam 21 has a first phase of free travel before it starts to slide along the entrance bevel 23 of the ramp 22. As a result, the cam 21 is forced to turn, and the slide block 25 comes into contact with the release device 18 of the sealing strip 17. As the closing movement of the sliding leaf 3 continues, the cam 21 continues to be turned by the ramp 22, so that the slide block 25 continues to press the release device 18 farther and farther inward, which has the effect of pushing the sealing strip 17 outward to a corresponding extent. By the time the leaf is completely closed, the sealing strip 17 is resting on the floor or on the threshold 7 to form a seal. All the other seals have also assumed effective positions by the time the sliding leaf 3 is closed; an additional horizontal sealing strip 30 between the housing 6 and the support profile 12 is also moved automatically into position.

During the normal door opening operation, no additional force component is required to retract the sealing strip 17, because the elastic restoring force of the sealing strip 17 fulfills this function. The release device 18 also presses the cam 21 back into its starting position.

When the sliding leaf 3 is swung open in a panic situation, the release device travels rotationally around the slide block 25 of the cam 21, which is held in position against the ramp 22. The radially descending design of the slide block 25 makes it possible here for the spring-loaded release device 18 to travel outward, which has the effect of lifting the sealing strip 17 from the floor. The door closer takes care of swinging the sliding leaf 3 shut; during this phase, the slide block 25 of the cam 21 controls the movement of the release device 18, which now travels back in the opposite direction. It follows from this that there is no interference with the function between the cam 21 and the release device 18 either during or after the swinging-open or the swinging-closed of the sliding leaf 3.

The vertical seal along the secondary contact edge 20 between the stationary side part 2 and the sliding leaf 3 is advantageously accomplished by an elastic sealing profile 31, which is mounted on the sliding leaf 3. The sealing profile 31 has the shape of a lip to minimize the load on the drive 5. A load-reducing effect is obtained here in that the lip travels along a wedge-shaped vertical profile (not shown), which is mounted on the side part 2. For the sake of protecting the fingers, a web is also provided to guarantee a safety gap with respect to the side part 2.

Sealing profiles 33 with sealing lips are mounted on the main contact edges 32 of the sliding leafs 3; these profiles perform the desired sealing function after the sliding leafs 3 have been swung shut even in the case of a dual-leaf door system 1. Here again, the actuating force which the drive 5 must produce is minimized.

The door system 1 is also adequately sealed along the top horizontal edges. The automatically actuated sealing strip 30 corresponds in its basic design to the sealing strip 17 at the bottom and is attached to the housing 6. The sealing strip 30 moves from the housing 6 toward the support profile 12 of the sliding leaf 3; an appropriate release device 18 is operated by a force-reducing lever 34, which is actuated by an arm 35 attached to the support profile 12, the arm having an end piece 36. The end piece 36 is designed so that it can be mounted on or under the arm 35, depending on the height at which the sliding leaf 3 is mounted. The way in which the sealing strip 30 operates is similar to that of the sealing strip 17 at the bottom; during the closing and opening of the sliding leaf 3, the movement of the sealing strip 30 is controlled by the arm 35, which is mounted on the support profile 12 and actuates the lever 34.

The horizontal sealing of the housing 5 against the ceiling is accomplished by extendable ceiling cover profiles (not shown) and possibly by silicone on the nonmoving parts. Extendable lining panels are also mounted on the edge areas of the vertical columns facing the wall, which panels are sealed with silicone if desired. The leakage points at the corners and transition areas are sealed by brush seals or molded plastic parts.

The preceding description of the exemplary embodiments according to the present invention serves only to illustrate the object of the invention, not to limit it. Within the scope of the invention, various changes and modifications can be made without abandoning the scope of either the invention itself or its equivalents.

List if Reference Numbers

1 sliding door system

2 side part

3 sliding leaf

4 runway rail

5 drive

6 housing

7 threshold

8 rail

9 frame

10 floor glide

11 support arm

12 support profile

13 carriage

14 profile

15 transverse profile

16 transverse profile

17 sealing strip

18 release device

19 longitudinal profile

20 secondary closing edge

21 cam

22 ramp

23 entrance bevel

24 lobe

25 slide block

26 stop

27 axle body

28 bearing block

29 opening

30 sealing strip

31 sealing profile

32 main closing edge

33 sealing profile

34 lever

35 arm

36 end piece

1. Sliding door system with at least one automatically driven sliding leaf (3), guided on a traveling carriage (13) and a support profile (12), where the drive (5) and a runway rail (4) are located in a housing (6) above the sliding leaf (3), and where the sliding leaf (3) can be swung outward around a vertical axis when necessary to open it, characterized in that, when in the closed position, the sliding leaf (3) has active sealing devices (17, 30), which are active at all times on all horizontal and vertical edges.

2. Sliding door system according to claim 1, characterized in that an automatically acting sealing strip (17) is mounted on the bottom of the sliding leaf (3).

3. Sliding door system according to claim 2, characterized in that a lowerable sealing strip (17), which can be released at a secondary contact edge (20) of the sliding leaf (3), is mounted in a transverse profile (16) at the bottom of the sliding leaf (3).

4. Sliding door system according to claim 2 or claim 3, characterized in that a cam (21) actuates the release device (18) of the sealing strip (17).

5. Sliding door system according to claim 4, characterized in that the cam (21) is rotatably supported on an axle body (27), which is mounted in a longitudinal profile (19) of the sliding leaf (3).

6. Sliding door system according to claim 4 or claim 5, characterized in that the cam (21) has a slide block (25), which actuates the release device (18).

7. Sliding door system according to claim 6, characterized in that the slide block (25) has an area which ascends or descends in the radial direction.

8. Sliding door system according to one of claims 4-7, characterized in that the cam (21) has stops (26).

9. Sliding door system according to one of claims 4-8, characterized in that the cam (21) has a projecting lobe (24).

10. Sliding door system according to one of claims 1-9, characterized in that a ramp (22) is permanently mounted on a side part (2) of the sliding door system (1) or on a stationary wall.

11. Sliding door system according to claim 10, characterized in that the ramp (22) has an entrance bevel (23).

12. Sliding door system according to one of claims 1-10, characterized in that a threshold (7) and/or a rail (8) is attached permanently to the side part (2) of the sliding door system (1) or to a stationary wall.

13. Sliding door system according to one of claims 4-12, characterized in that a bottom glide (10) is attached to the axle body (27).

14. Sliding door system according to claim 13, characterized in that the bottom glide (10) is positively guided in the rail (8).

15. Sliding door system according to claim 13 or claim 14, characterized in that the axle body (27), the bottom glide (10), and the cam (21) form an assembly.

16. Sliding door system according to claim 15, characterized in that the assembly is accessible via the longitudinal profile (19) and can be replaced without removing the leaf.

17. Sliding door system according to one of claims 1-16, characterized in that a vertical sealing profile (31) is mounted on the secondary contact edge (20) of the sliding leaf (3), which sealing profile works together with a profile attached to the side part (2).

18. Sliding door system according to one of claims 1-17, characterized in that a vertical sealing profile (33) with deflectable sealing lips is mounted on a main closing edge (32) of the sliding leaf (3).

19. Sliding door system according to one of claims 1-18, characterized in that the sealing strip (30) between the housing (6) and the support profile (12) has a cooperating lever (34), which is supported on the housing (6), which lever can be controlled by an arm (35) mounted on the support profile (12).

20. Sliding door system according to claim 19, characterized in that the sealing strip (30) is designed to move horizontally between the housing (6) and the support profile (12).

21. Sliding door system according to one of claims 1-20, characterized in that profiles which can be extended toward the periphery are mounted on the edges of the side parts (2) and/or of the housing (6) and/or that silicone is applied.

22. Sliding door system according to one of claims 1-21, characterized in that brush seals and molded plastic parts are mounted in the corner and transition areas.
